(19) United States
(12) Patent Application Publication
(10) Pub. No.: US 2025/0015316 A1
(43) Pub. Date: Jan. 9, 2025

(54) POWER GENERATION CELL

(71) Applicant: HONDA MOTOR CO., LTD., Tokyo (JP)

(72) Inventor: Suguru OMORI, Wako-shi (JP)

(21) Appl. No.: 18/760,586

(22) Filed: Jul. 1, 2024

(30) Foreign Application Priority Data
Jul. 3, 2023 (JP) 2023-109124

(51) Int. Cl. H01M 8/0273; H01M 8/0206; H01M 8/0254; H01M 8/0258; H01M 8/04089; H01M 8/10; H01M 8/1004

(52) U.S. Cl. CPC H01M 8/0273; H01M 8/0206; H01M 8/0254; H01M 8/0258; H01M 8/04089; H01M 8/1004; H01M 2008/1095

(57) ABSTRACT

A power generation cell of the present invention is provided with a reaction gas flow path that has a wavy shape and through which reaction gas flows along an electrolyte membrane electrode assembly from one end side of a separator toward the other end side, and a sealing part contacting a resin frame part of the electrolyte membrane electrode assembly and surrounding the reaction gas flow path to prevent leakage of the reaction gas. The sealing part includes a plurality of top parts that are convex on the reaction gas flow path side. Each top part of the reaction gas flow path, which is convex on the sealing part side is positioned on a straight line connecting two adjacent top parts of the sealing part or protrudes on the sealing part side beyond the straight line.

### CROSS-REFERENCE TO RELATED APPLICATION

This application is based upon and claims priority from the Japanese Patent Application No. 2023-109124, filed on 2023 Jul. 3, the entire contents of which are incorporated herein by reference.

### BACKGROUND OF THE INVENTION

### 1. Field of the Invention

The present invention relates to a power generation cell.

### 2. Description of the Related Art

Recently, research related to fuel batteries that contribute to energy efficiency have been made to ensure that a larger number of people have access to affordable, reliable, sustainable, and advanced energy.

Conventionally, a bipolar plate of a fuel battery having a channel structure in which a plurality of reaction gas flow paths are arranged alongside each other along an electrochemical active region of a polymer electrolytic membrane has been known (refer to Japanese Patent No. 5239091, for example). The bipolar plate includes a boundary wall (sealing part) formed along the periphery, and a restriction member made of a rib to prevent transport (bypass flow) of reaction gas between the boundary wall and the channel structure.

In such a fuel battery, a restriction member blocks bypass flow of reaction gas that would otherwise flow between the channel structure and the boundary wall while avoiding a power generation region. Accordingly, the reaction rate of reaction gas in the power generation region of the fuel battery increases.

Typically, the reaction gas flow paths of a bipolar plate are formed as groove parts (channel structures) at a plate surface when a plate body is pressed to produce the bipolar plate.

In a recent fuel battery, the pitch of reaction gas flow paths tends to decrease as the power generation region increases. Thus, deflection sometimes occurs to the bipolar plate due to excess material of the plate body at pressing.

In a case where a conventional fuel battery stack (refer to Japanese Patent No. 5239091, for example) is formed by using such a bipolar plate, variance occurs to surface pressure of the bipolar plate on the polymer electrolytic membrane in the power generation region and reaction gas is more likely to leak from the reaction gas flow paths. Furthermore, the restriction member of the bipolar plate, which blocks bypass flow, is formed to couple the boundary wall and an outer peripheral part of the channel structure, and thus leakage of reaction gas from the boundary wall (sealing part) is concerned because of a step generated between the boundary wall and the channel structure due to deflection of the bipolar plate (separator).

It is an objective of the present invention to provide a power generation cell capable of efficiently regulating bypass flow of reaction gas flowing while avoiding a power generation region and more reliably preventing leakage of the reaction gas. This contributes to energy efficiency.

### SUMMARY OF THE INVENTION

A power generation cell of the present invention achieving the above-described objective is a power generation cell including an electrolyte membrane electrode assembly provided with electrodes on respective sides of an electrolyte membrane, a resin frame part provided at an outer peripheral part of the electrolyte membrane electrode assembly, and a separator disposed on each side of the electrolyte membrane electrode assembly. The separator is a plate-shaped component made of metal and provided with a reaction gas flow path that has a wavy shape and through which reaction gas flows along the electrolyte membrane electrode assembly from one end of the separator toward the other end, and a sealing part contacting the resin frame part and surrounding the reaction gas flow path to prevent leakage of the reaction gas. The sealing part includes a plurality of top parts that are convex on the reaction gas flow path side. A top part of the reaction gas flow path, which is convex on the sealing part side is positioned on a straight line connecting two adjacent top parts of the sealing part or protrudes on the sealing part side beyond the straight line.

Another power generation cell of the present invention is a power generation cell including an electrolyte membrane electrode assembly provided with electrodes on respective sides of an electrolyte membrane, a resin frame part provided at an outer peripheral part of the electrolyte membrane electrode assembly, and a separator disposed on each side of the electrolyte membrane electrode assembly. The separator is a plate-shaped component made of metal and provided with a reaction gas flow path that has a wavy shape and through which reaction gas flows along the electrolyte membrane electrode assembly from one end of the separator toward the other end, and a sealing part contacting the resin frame part and surrounding the reaction gas flow path to prevent leakage of the reaction gas. The sealing part includes a top part that is convex on the reaction gas flow path side. A top part of the reaction gas flow path, which is convex on the sealing part side is formed at a position facing the top part of the sealing part, which is convex on the reaction gas flow path side.

With a power generation cell of the present invention, it is possible to efficiently regulate bypass flow of reaction gas flowing while avoiding a power generation region and more reliably prevent leakage of the reaction gas.

### BRIEF DESCRIPTION OF THE DRAWINGS

FIG. 1 is an exploded perspective view of a power generation cell according to an embodiment of the present invention;

FIG. 2 is a partially enlarged plan view of the power generation cell, corresponding to the position of arrowed part II in FIG. 1;

FIG. 3A is an IIIA-IIIA cross-sectional view of FIG. 2;

FIG. 3B is an IIIB-IIIB cross-sectional view of FIG. 2;

FIG. 4 is a cross-sectional view of a modification of an electrolyte membrane electrode assembly shown in FIG. 3B;

FIG. 5 is a plan view of a separator when viewed from the electrolyte membrane electrode assembly side;

FIG. 6A is a partially enlarged diagram of part VIA of FIG. 5;

FIG. 6B is a partially enlarged diagram of part VIB of FIG. 5;

FIG. 6C is a partially enlarged plan view of the separator, showing a state in which a concave part of a sealing part of the separator faces a convex part of a reaction gas flow path; and

FIG. 7 is a partially enlarged plan view of the power generation cell according to another embodiment.

### DETAILED DESCRIPTION OF THE EMBODIMENTS

An aspect (embodiment) for implementing a power generation cell of the present invention will be described below in detail with reference to the accompanying drawings as appropriate.

The power generation cell of the present embodiment has such main characteristics that: the power generation cell is provided such that a plurality of reaction gas flow paths each having a wavy shape and meandering in one direction on the surface of an electrolyte membrane electrode assembly (MEA) are arranged alongside each other at a separator; and convex parts of the wavy shapes of the reaction gas flow paths are disposed close to a reaction gas sealing part provided along the periphery of the separator, thereby forming a regulation part for bypass flow of reaction gas.

The following description will be first made on the entire configuration of the power generation cell and then made on the electrolyte membrane electrode assembly and the separator.

### <<Entire Configuration of Power Generation Cell>>

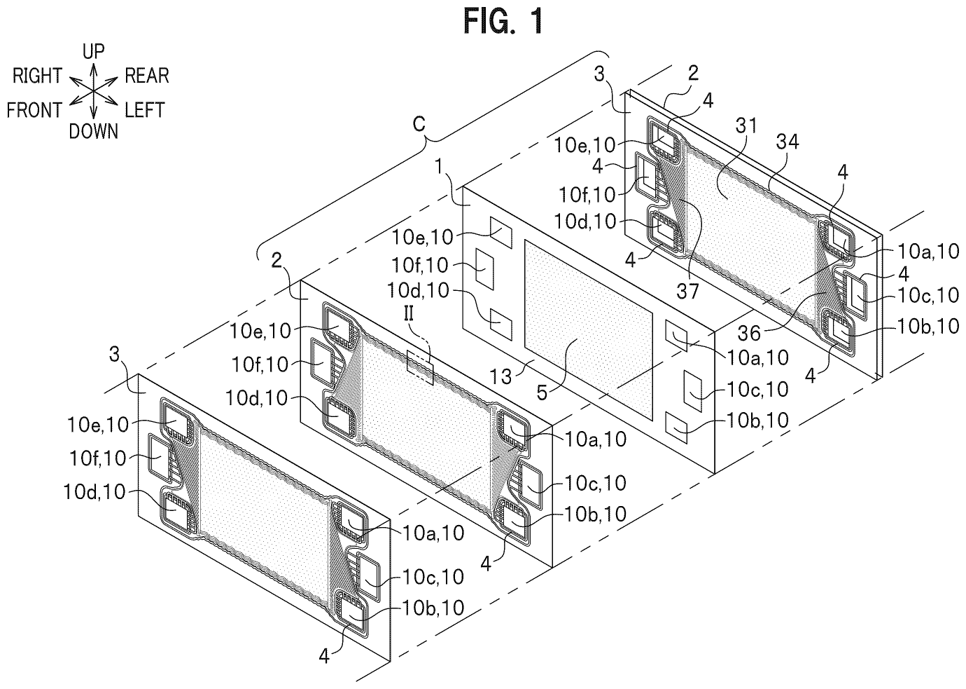

FIG. 1 is an exploded perspective view of a power generation cell C. Front, back, up, down, right, and left directions in the following description correspond to front, back, up, down, right, and left directions indicated with arrows in FIG. 1. However, the front, back, up, down, right, and left directions shown in FIG. 1 are set for convenience to specifically describe the configuration of each component of the power generation cell C and do not indicate absolute directions of the power generation cell C.

As shown in FIG. 1, the power generation cell C is a unit cell constituted by an electrolyte membrane electrode assembly 1 and a pair of separators (a cathode side separator 2 and an anode side separator 3) sandwiching the electrolyte membrane electrode assembly 1.

A fuel battery is used as a fuel battery stack including a cell unit (not shown) in which such power generation cells C (unit cells) are stacked in the front-back direction. It is assumed that the cell unit in the present embodiment is constituted by, for example, the cathode side separator 2 disposed alongside on the cathode side of the electrolyte membrane electrode assembly 1 shown in FIG. 1, the anode side separator 3 disposed back-to-back with the cathode side separator 2, and a non-shown electrolyte membrane electrode assembly disposed such that the anode side thereof faces the anode side separator 3.

In addition, a non-shown electrolyte membrane electrode assembly 1 is disposed alongside the anode side separator 3 disposed on the anode side of the electrolyte membrane electrode assembly 1 shown in FIG. 1, whereas the cathode side separator 2 disposed back-to-back with the anode side separator 3 is interposed therebetween, such that the cathode side of the non-shown electrolyte membrane electrode assembly 1 faces the cathode side separator 2.

In FIG. 1, reference sign 10a denotes a reaction gas supply port that supplies oxygen containing gas (oxidant gas), reference sign 10b denotes a reaction gas discharge port that discharges hydrogen containing gas (fuel gas), and reference sign 10c denotes a cooling medium supply port that supplies a cooling medium (for example, water or oil).

In addition, in FIG. 1, reference sign 10d denotes a reaction gas discharge port that discharges oxygen containing gas (oxidant gas), reference sign 10e denotes a reaction gas supply port that supplies hydrogen containing gas (fuel gas), and reference sign 10f denotes a cooling medium discharge port that discharges a cooling medium.

The reaction gas supply ports 10a and 10e, the reaction gas discharge ports 10d and 10b, the cooling medium supply port 10c, and the cooling medium discharge port 10f are formed at each of the electrolyte membrane electrode assembly 1, the cathode side separator 2, and the anode side separator 3. The reaction gas supply ports 10a and 10e, the reaction gas discharge ports 10d and 10b, the cooling medium supply ports 10c, and the cooling medium discharge ports 10f are integrated to form communication holes 10 extending in the front-back direction when a plurality of power generation cells C are stacked.

The number of stacked power generation cells C (unit cells) can be set in accordance with power generation capacity requested for the fuel battery. In the present embodiment, the fuel battery is assumed to be constituted by several hundred cells continuously provided in series but is not limited thereto.

The cathode side separator 2 and the anode side separator 3 in the present embodiment are integrally joined back-to-back with each other by welding or the like in advance.

Although not shown, at each end part of a cell unit constituted by a plurality of power generation cells C (unit cells), such a fuel battery using power generation cells C includes a terminal plate, an insulation plate, and an end plate in the stated order from the cell unit side toward the outside. The plurality of power generation cells constituting the cell unit are integrally fastened by a predetermined load between the end plates at the respective ends.

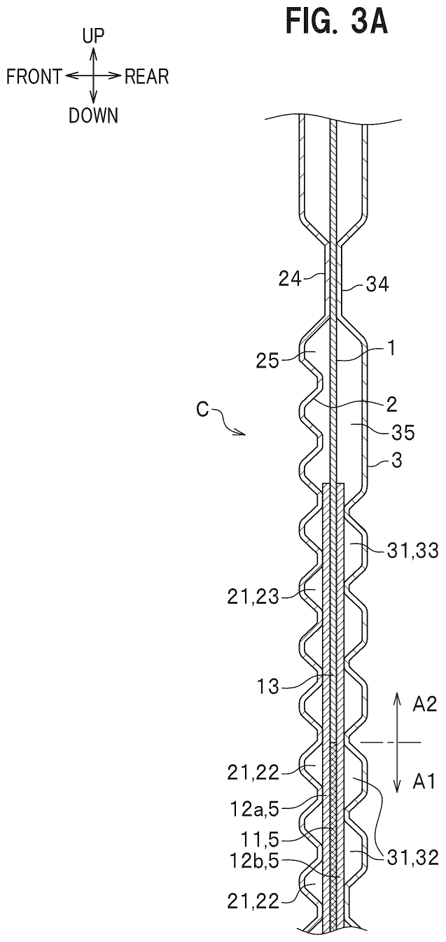

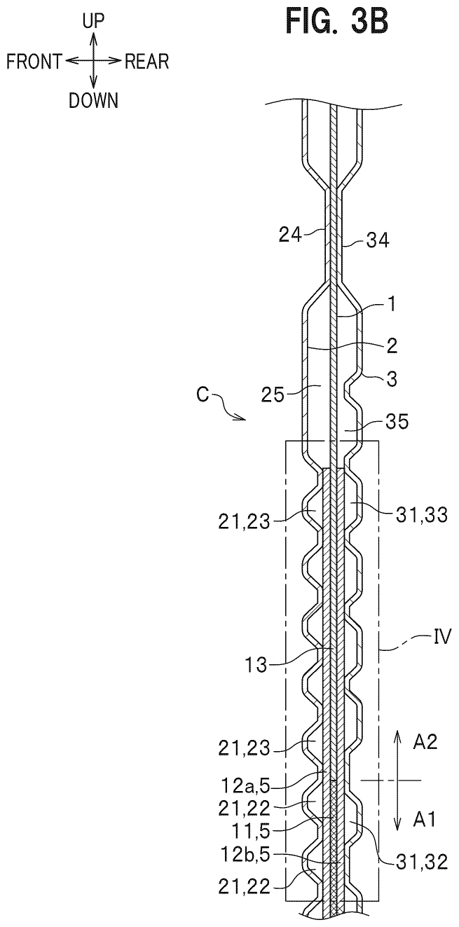

Accordingly, the cathode side separator 2 and the anode side separator 3 sandwich the electrolyte membrane electrode assembly 1 by a predetermined load with their reaction gas flow paths 21 and 31 (refer to FIG. 3A) positioned inside.

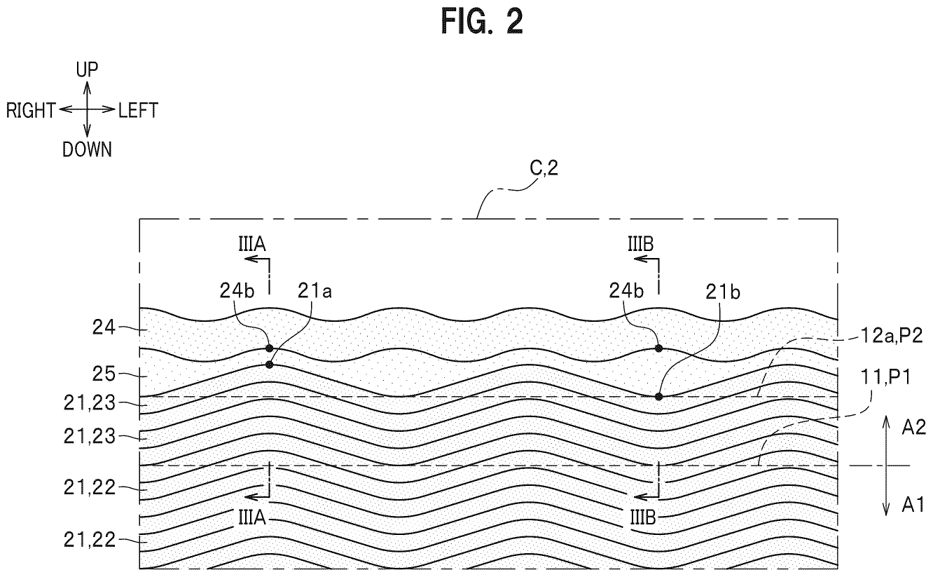

FIG. 2 is a partially enlarged plan view of the power generation cell C (unit cell), corresponding to the position of arrowed part II in FIG. 1. Specifically, FIG. 2 is a partially enlarged plan view of the back surface of the cathode side separator 2 in the power generation cell C. FIG. 3A is an IIIA-IIIA cross-sectional view of the power generation cell C shown in FIG. 2. FIG. 3A is a cross-sectional view at the central position of a convex part 21a of the reaction gas flow path 21 to be described later in a square view (front view) of the power generation cell C. FIG. 3B is an IIIB-IIIB cross-sectional view of the power generation cell C shown in FIG. 2. FIG. 3B is a cross-sectional view at the central position of a concave part 21b of the reaction gas flow path 21 to be described later in a square view (front view) of the power generation cell C.

As shown in FIG. 2, the back surface of the cathode side separator 2, which serves as the front surface of the power generation cell C, is formed in an inverted concave-convex shape of the reaction gas flow path 21 (refer to FIG. 3A) having a groove shape, a sealing part 24 (refer to FIG. 3A) having a bead shape, and a bypass flow path 25 (refer to FIG. 3A) having a groove shape, which will be described later in detail.

The inverted concave-convex shape is formed by inverting the concave-convex shape of the reaction gas flow path 21 (refer to FIG. 3A), the sealing part 24 (refer to FIG. 3A), and the bypass flow path 25 (refer to FIG. 3A) between the front and back of the cathode side separator 2 when the cathode side separator 2 is produced by pressing a plate body made of metal.

As described later in detail, the back surface of the anode side separator 3 (refer to FIG. 1), which serves as the back surface of the power generation cell C, is formed in an inverted concave-convex shape of the reaction gas flow path 31 (refer to FIG. 3A), a sealing part 34 (refer to FIG. 3A), and a bypass flow path 35 (refer to FIG. 3A).

### <<Electrolyte Membrane Electrode Assembly>>

The electrolyte membrane electrode assembly 1 is formed of a thin plate body having a plane shape in a rectangle that is long in the right-left direction as shown in FIG. 1.

The electrolyte membrane electrode assembly 1 includes a rectangular electrolyte membrane electrode part 5 at a central part in a square view (front view), and a resin frame part 13 forming an outer peripheral part of the electrolyte membrane electrode assembly 1 to border the periphery of the electrolyte membrane electrode part 5.

The reaction gas supply port 10a, the reaction gas discharge port 10b, and the cooling medium supply port 10c described above are formed at a left end part of the resin frame part 13 in the present embodiment. In addition, the reaction gas discharge port 10d, the reaction gas supply port 10e, and the cooling medium discharge port 10f are formed at a right end part of the resin frame part 13.

The material of such a resin frame part 13 is not particularly limited but may be any proton non-conductive resin having a predetermined thermal resistance and is preferably an engineering plastic film of polyphenylene sulfide (PPS) or the like.

As shown in FIGS. 3A and 3B, the electrolyte membrane electrode part 5 (refer to FIG. 1) included in the electrolyte membrane electrode assembly 1 includes an electrolyte membrane 11, a cathode 12a (oxygen electrode) formed on one surface of the electrolyte membrane 11, and an anode 12b (fuel electrode) formed on the other surface.

The electrolyte membrane 11 in the present embodiment is assumed to be a proton exchange membrane made of polymer solid electrolyte.

Although not shown, the cathode 12a and the anode 12b each include a gas diffusion layer made of carbon fiber paper, and a catalyst layer formed by applying an ion conductive resin composition containing a catalyst such as platinum to a surface of the gas diffusion layer on a side contacting the electrolyte membrane 11.

The cathode 12a and the anode 12b in the present embodiment are each partially placed over the resin frame part 13 forming the outer peripheral part of the electrolyte membrane electrode assembly 1 as shown in FIGS. 3A and 3B.

Specifically, outer edge parts (upper edge parts in FIGS. 3A and 3B) of the cathode 12a and the anode 12b in the present embodiment are disposed to sandwich an inner edge part (lower edge part in FIGS. 3A and 3B) of the resin frame part 13 in the front-back direction.

In such an electrolyte membrane electrode assembly 1, a region where the cathode 12a and the anode 12b sandwich the electrolyte membrane 11 forms a power generation region A1 that is electrochemically active as shown in FIGS. 3A and 3B.

Hydrogen containing gas (fuel gas) is supplied to the anode 12b included in the power generation region A1 from first reaction gas flow paths 32 to be described later in detail. Hydrogen having reached the catalyst layer (not shown) through the gas diffusion layer (not shown) of the anode 12b is disassembled into an electron and a proton. The electron is taken out to an external circuit connected to the anode 12b, and the proton passes through the electrolyte membrane 11 and reaches the catalyst layer (not shown) of the cathode 12a included in the power generation region A1.

In addition, oxygen containing gas (oxidant gas) is supplied to the cathode 12a from a first reaction gas flow path 22 to be described later in detail. The oxygen reaches the catalyst layer (not shown) through the gas diffusion layer of the cathode 12a.

In the catalyst layer of the cathode 12a, the proton having reached from the electrolyte membrane 11 side, the oxygen, and the electron having reached through the external circuit are coupled to generate water. Through this series of processes, flow of electrons taken out to the external circuit is used as power generation electric power.

As shown in FIGS. 3A and 3B, a region where the proton-nonconductive resin frame part 13 is disposed between the cathode 12a and the anode 12b serves as a non-power generation region A2 that does not contribute to power generation.

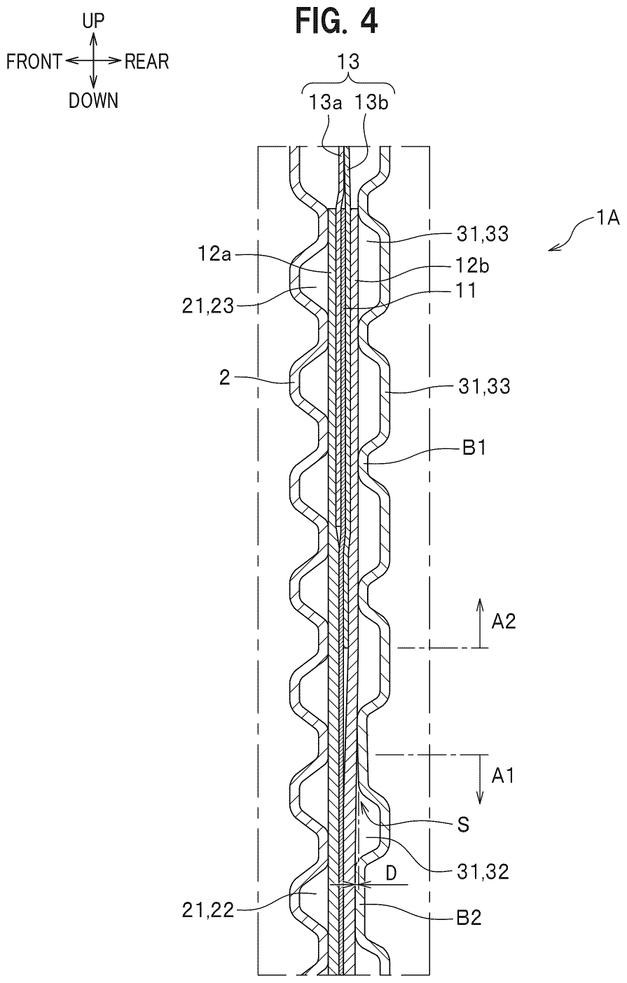

FIG. 4 is a cross-sectional view of an electrolyte membrane electrode assembly 1A as a modification of the above-described electrolyte membrane electrode assembly 1 (refer to FIGS. 3A and 3B). FIG. 4 corresponds to FIG. 3B. In FIG. 4, the same constituent component as in the electrolyte membrane electrode assembly 1 (refer to FIG. 3B) is denoted by the same reference sign and detailed description thereof is omitted. FIG. 4 schematically shows the electrolyte membrane electrode assembly 1A in a state in which power generation cells C (refer to FIG. 1) are stacked and a predetermined load is applied between each pair of the cathode side separator 2 and the anode side separator 3.

As shown in FIG. 4, the resin frame part 13 forming an outer peripheral part of the electrolyte membrane electrode assembly 1A is constituted by a resin frame part 13a and a resin frame part 13b.

Specifically, the resin frame part 13 includes the resin frame part 13a disposed adjacent to the cathode side separator 2, and the resin frame part 13b disposed adjacent to the anode side separator 3.

The electrolyte membrane 11 of the electrolyte membrane electrode assembly 1A is disposed between the cathode 12a and the anode 12b to extend to end edges of the cathode 12a and the anode 12b. In other words, the cathode 12a and the anode 12b are each formed and disposed corresponding to a membrane surface of the electrolyte membrane 11.

The resin frame part 13a is sandwiched between an end part of the cathode 12a and an end part of the electrolyte membrane 11. The cathode 12a and the electrolyte membrane 11 are bonded to the resin frame part 13a at a part where the resin frame part 13a is sandwiched.

The resin frame part 13b is sandwiched between an end part of the anode 12b and the end part of the electrolyte membrane 11. The anode 12b and the electrolyte membrane 11 are bonded to the resin frame part 13b at a part where the resin frame part 13b is sandwiched.

A length by which the resin frame part 13b is sandwiched between the anode 12b and the electrolyte membrane 11 is longer than a length by which the resin frame part 13a is sandwiched between the cathode 12a and the electrolyte membrane 11.

The resin frame part 13a and the resin frame part 13b are integrally bonded to each other except for a part disposed between the cathode 12a and the anode 12b.

In such an electrolyte membrane electrode assembly 1A, a region where the cathode 12a and the anode 12b sandwich the electrolyte membrane 11 forms the electrochemically active power generation region A1 as shown in FIG. 4. In addition, a region where at least one (in FIG. 4, the resin frame part 13b) of the resin frame part 13a and the resin frame part 13b is disposed between the cathode 12a and the anode 12b forms the non-power generation region A2 that does not contribute to power generation.

In such an electrolyte membrane electrode assembly 1A, the resin frame part 13a and the resin frame part 13b sandwich the electrolyte membrane 11 between the cathode 12a and the anode 12b as shown in FIG. 4. Accordingly, joint strength of the resin frame part 13 in the electrolyte membrane electrode assembly 1A is further improved.

The electrolyte membrane electrode assembly 1A as the modification shown in FIG. 4 is configured also based on an assumption that the thickness of a part where the resin frame parts 13a and 13b are provided between the cathode 12a and the anode 12b in the stack direction is larger than the thickness of a part where the resin frame parts 13a and 13b are not provided. Specifically, the electrolyte membrane electrode assembly 1A has a step of a width D between the part where the resin frame parts 13a and 13b are provided between the cathode 12a and the anode 12b and the part where the resin frame parts 13a and 13b are not provided.

Thus, the electrolyte membrane electrode assembly 1A allows for some thickness variation in accordance with, for example, design compression allowance of the gas diffusion layer used in each of the cathode 12a and the anode 12b when stacked.

In the electrolyte membrane electrode assembly 1A shown in FIG. 4, a slope S is assumed in an interval where transition occurs from the part where the resin frame parts 13a and 13b are provided to the part where the resin frame parts 13a and 13b are not provided. The slope S is formed mainly on the anode 12b side rather than on the cathode 12a side.

In the electrolyte membrane electrode assembly 1A, transition from the part where the resin frame parts 13a and 13b are provided to the part where the resin frame parts 13a and 13b are not provided is gentle. Specifically, the resin frame part 13b disposed between the cathode 12a and the anode 12b is longer than the resin frame part 13a.

The cathode side separator 2 and the anode side separator 3 sandwiching such an electrolyte membrane electrode assembly 1A elastically deforms due to a load when stacked and contacts the electrolyte membrane electrode assembly 1A with pressure.

Specifically, at a part where the resin frame part 13 is provided between the cathode 12a and the anode 12b, the anode side separator 3 contacts the electrolyte membrane electrode assembly 1A with pressure at a bead part B1 formed between reaction gas flow paths 31.

At a part where the resin frame part 13 is not provided between the cathode 12a and the anode 12b, the anode side separator 3 contacts the electrolyte membrane electrode assembly 1A with pressure at a bead part B2 formed between reaction gas flow paths 31.

The bead part B1 is designed such that its contact surface with the electrolyte membrane electrode assembly 1A is positioned with further displacement in a direction departing from the electrolyte membrane electrode assembly 1A than a contact surface of the bead part B2 to achieve equivalent surface pressure on the electrolyte membrane electrode assembly 1A to that by the bead part B2. Specifically, the anode side separator 3 has a step of a width D between the bead part B1 and the bead part B2.

However, beads of the cathode side separator 2 are disposed flush with no step.

As described later in detail, the anode side separator 3 is assumed to be set such that the reaction gas flow paths 31 have a larger flow path cross-sectional area and a longer pitch than the reaction gas flow paths 21 of the cathode side separator 2. Accordingly, the anode side separator 3 more elastically deforms than the cathode side separator 2 when contacting the electrolyte membrane electrode assembly 1A with pressure.

Thus, in the electrolyte membrane electrode assembly 1A, the slope S is formed on the anode side separator 3 side, which more elastically deforms when contacting with pressure, to assure a favorable sealing property between adjacent reaction gas flow paths 31.

### <<Separator>>

Each reaction gas flow path 21 of the cathode side separator 2 extends from one end side of the cathode side separator 2 toward the other end side as shown in FIG. 2. Specifically, each reaction gas flow path 21 is formed in a wavy shape with a constant wavelength and a constant amplitude in a square view (front view) of the power generation cell C shown in FIG. 2.

The waveform of each reaction gas flow path 21 in the present embodiment is different from a sine wave in that the waveform includes a straight part between peaks and valleys. However, the waveform of the reaction gas flow path 21 may be a sine wave.

The reaction gas flow paths 21 are arranged alongside each other in a direction orthogonal to the meandering direction (the right-left direction in FIG. 2). Specifically, the reaction gas flow paths 21 are disposed such that the reaction gas flow paths 21 closely contact each other in the up-down direction in FIG. 2 with the phases of their waveforms matched.

As shown in FIG. 3A, the sectional shape of each reaction gas flow path 21 is an equilateral trapezoid shape. Specifically, the sectional shape of the reaction gas flow path 21 is an equilateral trapezoid shape with a longer bottom base on the cathode 12a side than the top base.

As shown in FIGS. 2 and 3A, such reaction gas flow paths 21 of the cathode side separator 2 include first reaction gas flow paths 22 for supplying oxygen containing gas (reaction gas) to the cathode 12a included in the power generation region A1, and second reaction gas flow paths 23 arranged alongside the first reaction gas flow paths 22 and corresponding to the non-power generation region A2.

As shown in FIG. 2, each first reaction gas flow path 22 is disposed at least partially in contact with the electrolyte membrane 11, a position P1 of the upper end edge of which is shown with a hidden line (dotted line). As shown in FIG. 2, the power generation region A1 and the non-power generation region A2 of the power generation cell C are defined across the end edge of the electrolyte membrane 11.

As shown in FIG. 2, each second reaction gas flow path 23 is disposed at least partially in contact with the cathode 12a, a position P2 of an upper end edge of which shown with a hidden line (dotted line). Specifically, the second reaction gas flow path 23 is disposed at least partially in contact with the gas diffusion layer (not shown) of the cathode 12a (refer to FIG. 3A) placed over the proton-nonconductive resin frame part 13 (refer to FIG. 3A).

As shown in FIG. 2, the second reaction gas flow paths 23 are disposed between the sealing part 24 to be described next and the first reaction gas flow paths 22 and arranged alongside the first reaction gas flow path 22.

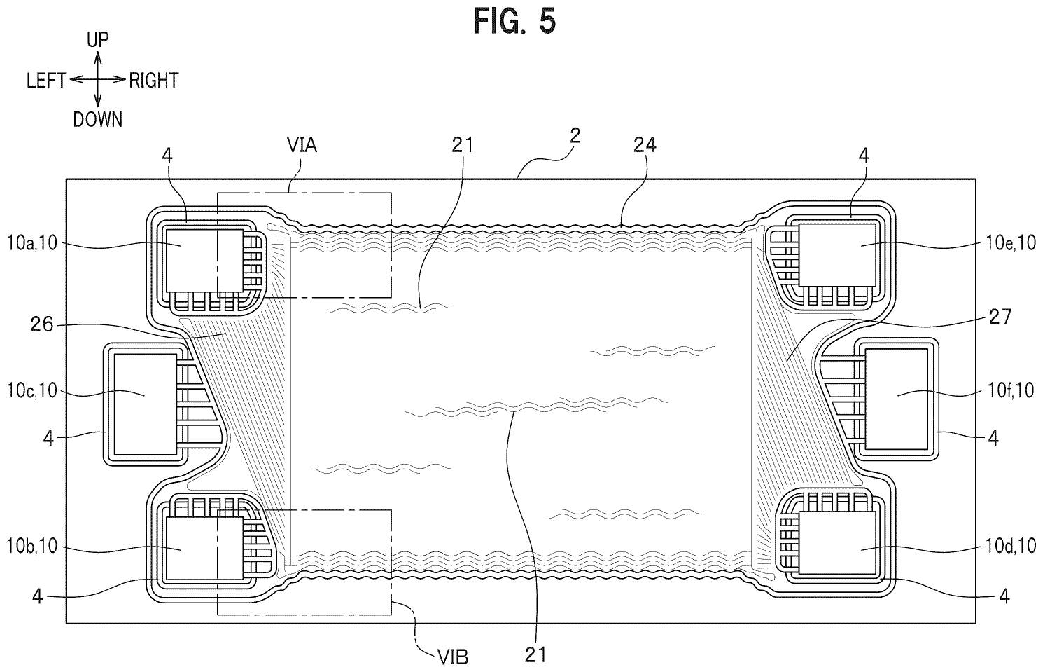

FIG. 5 is a plan view (back surface diagram) of the cathode side separator 2 shown in FIG. 1 when viewed from the electrolyte membrane electrode assembly 1 side. In FIG. 5, the reaction gas flow paths 21 arranged alongside each other in the up-down direction on the back surface of the cathode side separator 2 are simplified for convenience sake.

As shown in FIG. 5, the sealing part 24 of the cathode side separator 2 is formed around the reaction gas flow paths 21 arranged alongside each other in a back surface view (plan view).

The sealing part 24 is formed in an annular shape integrally surrounding the reaction gas supply port 10a for supplying oxygen containing gas (oxidant gas) to the reaction gas flow paths 21, the reaction gas discharge port 10d for discharging oxygen containing gas (oxidant gas) from the reaction gas flow paths 21, an introduction path 26 made of a groove for guiding oxygen containing gas (oxidant gas) from the reaction gas supply port 10a to the reaction gas flow path 21, a discharge path 27 made of a groove for guiding oxygen containing gas (oxidant gas) from the reaction gas flow path 21 to the reaction gas discharge port 10d, and the reaction gas discharge port 10d and the reaction gas supply port 10e for supplying and discharging hydrogen containing gas (fuel gas) to and from the anode side separator 3 (refer to FIG. 1).

As shown in FIGS. 3A and 3B, such a sealing part 24 contacts the resin frame part 13 of the electrolyte membrane electrode assembly 1 to prevent leakage of oxygen containing gas (oxidant gas) from the power generation cell C. Specifically, the sealing part 24 having a bead shape functions to seal oxygen containing gas (oxidant gas) by elastically deforming due to a load when the cathode side separator 2 is stacked as described above and contacting the electrolyte membrane electrode assembly 1 with pressure.

In FIG. 5, reference sign 4 denotes opening seals individually surrounding the reaction gas supply port 10a and the reaction gas discharge port 10d, respectively. Such opening seals 4 are also provided for the communication holes 10 for supplying and discharging hydrogen containing gas (fuel gas) to and from the anode side separator 3 (refer to FIG. 1), and the communication holes 10 for supplying and discharging a cooling medium between the cathode side separator 2 and the anode side separator 3 (refer to FIG. 1).

As shown in FIG. 2, the sealing part 24 in the present embodiment is formed in a wavy shape with a constant wavelength and a constant amplitude at a part adjacent to the reaction gas flow paths 21.

Specifically, the sealing part 24 is formed outside and alongside second reaction gas flow paths 23 at respective end parts of the power generation cell C in the vertical width direction.

Specifically, in the power generation cell C of the present embodiment, the second reaction gas flow paths 23 are formed corresponding to the non-power generation region A2 outside the first reaction gas flow paths 22 arranged alongside each other to supply reaction gas to the power generation region A1, and the sealing part 24 is provided outside the second reaction gas flow paths 23 with the bypass flow path 25 interposed therebetween.

As shown in FIG. 2, the wavelength of the waveform of the sealing part 24 is half the wavelength of the waveform of each reaction gas flow path 21. The convex part 21a of the wavy line of each second reaction gas flow path 23 faces a concave part 24b of the wavy line of the sealing part 24 in the up-down direction. The concave part 21b of the wavy line of each second reaction gas flow path 23 faces the concave part 24b of the wavy line of the sealing part 24.

Accordingly, the width of the bypass flow path 25 at a part where the concave part 24b of the sealing part 24 and the convex part 21a of each second reaction gas flow path 23 face each other is narrower than the width of the bypass flow path 25 at a part where the concave part 24b of the sealing part 24 and the concave part 21b of each second reaction gas flow path 23 face each other.

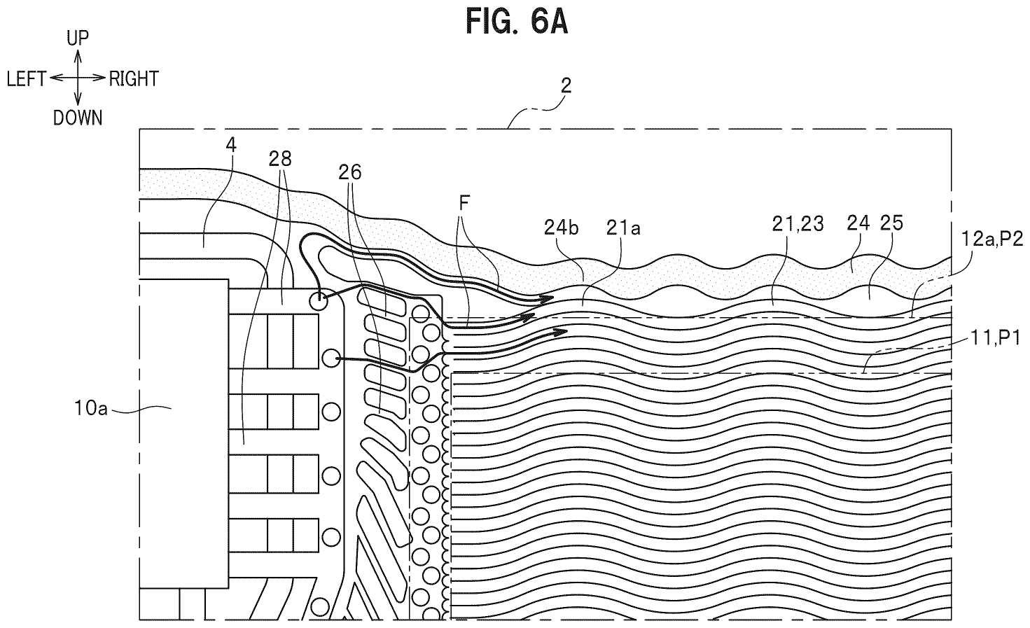

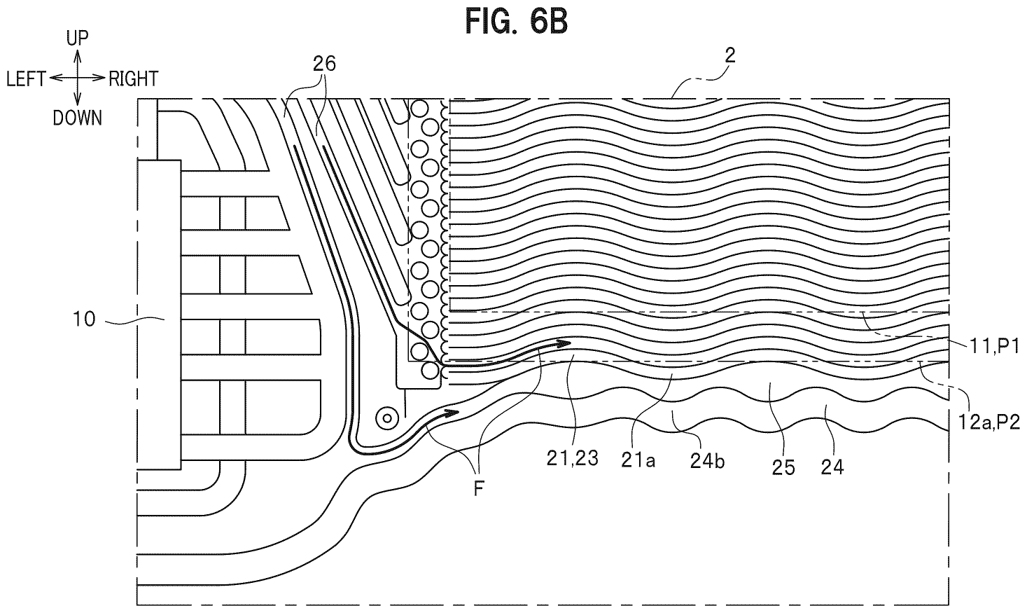

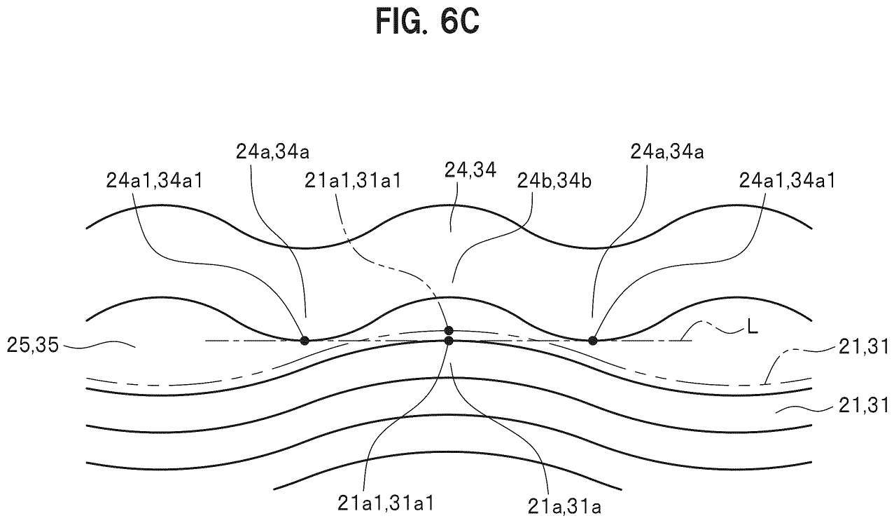

FIG. 6A is a partially enlarged diagram of part VIA of FIG. 5. FIG. 6B is a partially enlarged diagram of part VIB of FIG. 5.

As shown in FIG. 6A, in the cathode side separator 2 in the present embodiment, the convex part 21a of each second reaction gas flow path 23 faces the concave part 24b of the sealing part 24 at an upstream part of the reaction gas flow paths 21 on the reaction gas supply port 10a side, in other words, the second reaction gas flow paths 23 as the reaction gas flow paths 21 closest to the sealing part 24.

As shown in FIG. 6B, the convex part 21a of each second reaction gas flow path 23 faces the concave part 24b of the sealing part 24 at an upstream part of the second reaction gas flow paths 23 as the reaction gas flow paths 21 closest to the sealing part 24 on the lower end side of the cathode side separator 2.

In FIGS. 6A and 6B, reference sign F denotes an arrow indicating flow of reaction gas from the reaction gas supply port 10a (refer to FIG. 6A) to the reaction gas flow paths 21 and the bypass flow path 25 through the introduction path 26. Reference sign P1 denotes the position of the outer periphery of the electrolyte membrane 11 (refer to FIG. 3A), which is shown with a virtual line (dashed and double-dotted line). Reference sign P2 denotes the position of the outer periphery of the cathode 12a (refer to FIG. 3A), which is shown with a virtual line (dashed and double-dotted line). In FIG. 6A, reference sign 28 denotes a communication path providing communication between the reaction gas supply port 10a and the introduction path 26 beyond an opening seal 4. In FIG. 6B, reference sign 10 denotes a communication hole for supplying hydrogen containing gas (fuel gas) to the anode side separator 3 (refer to FIG. 1).

FIG. 6C is a partially enlarged plan view schematically showing a state in which the concave part 24b of the sealing part 24 faces the convex part 21a of each reaction gas flow path 21.

As shown in FIG. 6C, a top part 21al of the convex part 21a of the reaction gas flow path 21 is positioned between top parts 24al of two adjacent convex parts 24a of the sealing part 24.

The top part 21al of the convex part 21a of the reaction gas flow path 21 is assumed to be positioned on a straight line L connecting the top parts 24al of two adjacent convex parts 24a of the sealing part 24.

The convex parts 24a of the sealing part 24 and the convex part 21a of the reaction gas flow path 21 form a regulation part that regulates inflow of reaction gas (oxygen containing gas) in the bypass flow path 25. Accordingly, the regulation part in the present embodiment is formed as a narrow interval extending relatively long in the transport direction of reaction gas. Specifically, the regulation part is formed where slant faces of the convex parts 24a are close to slant faces of the convex part 21a. Such a regulation part formed where slant faces of the convex parts 24a are close to slant faces of the convex part 21a can be ensured to be long in the transport direction of reaction gas as compared to a regulation part formed where the top part 24al of a convex part 24a faces the top part 21al of a convex part 21a.

As shown with a virtual line (dashed and double-dotted line) in FIG. 6C, the top part 21al of each convex part 21a of the reaction gas flow path 21 may protrude on the sealing part 24 side beyond the straight line L. Accordingly, inflow of reaction gas (oxygen containing gas) to the bypass flow path 25 is further effectively regulated.

The anode side separator 3 (refer to FIG. 1) will be described below.

As shown in FIG. 1, a surface of the anode side separator 3, which faces the electrolyte membrane electrode assembly 1 is provided with the reaction gas flow paths 31 corresponding to the reaction gas flow paths 21 (refer to FIG. 5) of the cathode side separator 2.

In the anode side separator 3, hydrogen containing gas (fuel gas) supplied to an introduction path 36 from a reaction gas supply port 10eb flows through the reaction gas flow paths 31 and is discharged to the reaction gas discharge port 10b through a discharge path 37.

Similarly to the reaction gas flow paths 21 (refer to FIG. 5) of the cathode side separator 2, the reaction gas flow paths 31 extend one end side of the anode side separator 3 toward the other end side. Specifically, each reaction gas flow path 31 shown in FIG. 1 is formed in a wavy shape meandering in one direction from the left side to the right side with a constant wavelength and a constant amplitude.

The reaction gas flow paths 31 are disposed alongside each other in a direction orthogonal to the meandering direction (the right-left direction in FIG. 1) such that the reaction gas flow paths 31 closely contact each other with the phases of their waveforms matched.

The sectional shape of each reaction gas flow path 31 is an equilateral trapezoid shape as shown in FIGS. 3A and 3B.

As shown in FIGS. 3A and 3B, the reaction gas flow paths 31 include the first reaction gas flow paths 32 for supplying hydrogen containing gas (reaction gas) to the anode 12b included in the power generation region A1, and second reaction gas flow paths 33 arranged alongside the first reaction gas flow paths 32 and corresponding to the non-power generation region A2. The first reaction gas flow paths 32 are disposed at least partially in contact with the electrolyte membrane 11. A separator part forming the second reaction gas flow paths 33, together with a separator part of forming the second reaction gas flow paths 23 of the cathode side separator 2, sandwich the resin frame part 13 through the cathode 12a and the anode 12b.

As shown in FIGS. 3A and 3B, it is assumed that the reaction gas flow paths 31 of the anode side separator 3 are set to have a larger flow path cross-sectional area and a longer pitch than the reaction gas flow paths 21 of the cathode side separator 2. Although not shown, the wavelength of the waveform of each reaction gas flow path 31 of the anode side separator 3 is set to be equal to the wavelength of each reaction gas flow path 21 of the cathode side separator 2, but the present invention is not limited thereto. In a case where each reaction gas flow path 31 and each reaction gas flow path 21 are set to have equal wavelengths, the reaction gas flow paths are preferably disposed such that their phases are shifted from each other.

In FIG. 1, reference sign 34 denotes the sealing part of the anode side separator 3. The sealing part 34 is formed in an annular shape in the front view (plan view) shown in FIG. 1 like the sealing part 24 (refer to FIG. 5) of the cathode side separator 2. Specifically, the sealing part 34 is formed integrally surrounding the reaction gas flow paths 31, the reaction gas supply port 10e, the reaction gas discharge port 10b, the introduction path 36, the discharge path 37, and the reaction gas supply port 10a and the reaction gas discharge port 10d for supplying and discharging oxygen containing gas (oxidant gas) to the cathode side separator 2 (refer to FIG. 1).

As shown in FIGS. 3A and 3B, the sealing part 34 contacts the resin frame part 13 of the electrolyte membrane electrode assembly 1 to prevent leakage of hydrogen containing gas (fuel gas) from the power generation cell C. Specifically, the sealing part 34 having a bead shape functions to seal hydrogen containing gas (fuel gas) by elastically deforming due to a load when the anode side separator 3 is stacked as described above and contacting the electrolyte membrane electrode assembly 1 with pressure.

As shown in FIG. 1, the sealing part 34 in the present embodiment is formed in a wavy shape with a constant wavelength and a constant amplitude at a part adjacent to the reaction gas flow paths 31.

As shown in FIGS. 3A and 3B, the sealing part 34 is formed outside and alongside the second reaction gas flow paths 33 in the vertical width direction of the power generation cell C.

Specifically, in the anode side separator 3 in the present embodiment, the second reaction gas flow paths 33 are formed corresponding to the non-power generation region A2 outside the first reaction gas flow paths 32 arranged alongside each other to supply reaction gas to the power generation region A1, and the sealing part 34 is provided outside the second reaction gas flow paths 33 with the bypass flow path 35 interposed therebetween.

Although not shown, similarly to the relation between the sealing part 24 (FIG. 6C) and each reaction gas flow path 21 (FIG. 6C) in the cathode side separator 2, the sealing part 34 is assumed to be formed in a waveform with a wavelength half the wavelength of the waveform of each reaction gas flow path 31. As shown in FIG. 6C, a top part 31al of a convex part 31a of each reaction gas flow path 31 is assumed to be positioned on the straight line L connecting top parts 34al of two adjacent convex parts 34a of the sealing part 34 or protrude on the sealing part 34 side beyond the straight line L. The convex part 31a of the reaction gas flow path 31 and the convex parts 34a of the sealing part 34 form a regulation part that regulates inflow of reaction gas (hydrogen containing gas) to the bypass flow path 35.

In FIG. 1, reference sign 4 denotes opening seals individually surrounding the reaction gas discharge port 10b and the reaction gas discharge port 10d. Such opening seals 4 are also provided for the communication holes 10 for supplying and discharging oxygen containing gas (oxidant gas) and the communication holes 10 for supplying and discharging a cooling medium.

### <Effects>

Effects achieved by the power generation cell C according to the present embodiment will be described below.

A conventional power generation cell (refer to Japanese Patent No. 5239091, for example) includes a restriction member configured to block bypass flow of reaction gas.

Such a restriction member increases the reaction rate of reaction gas in a power generation region but potentially causes surface pressure variance based on deflection of a separator. In other words, in the conventional power generation cell (refer to Japanese Patent No. 5239091, for example) including the restriction member, increase of the reaction rate of reaction gas and variance prevention of surface pressure of the separator are in a trade-off relation. In particular, this tendency is significant for a power generation cell in which the restriction member is formed as a rib extending in a direction intersecting a direction in which reaction gas flow paths extend.

However, in the cathode side separator 2 of the power generation cell C of the present embodiment, the top part 21al of each convex part 21a of a reaction gas flow path 21 is positioned on the straight line L connecting the top parts 24al of two adjacent convex parts 24a of the sealing part 24 or protrudes on the sealing part 24 side beyond the straight line L.

In the bypass flow path 25 of the power generation cell C, a regulation part that regulates inflow of reaction gas is formed at a narrow interval extending relatively long in the transport direction of reaction gas by each concave part 24b of the sealing part 24 and the facing convex part 21a of the reaction gas flow path 21.

According to the power generation cell C including such a cathode side separator 2, the flow rate of reaction gas bypassing the power generation region A1 is decreased by the regulation part formed with each convex part 24a of the sealing part 24 and the corresponding convex part 21a of a reaction gas flow path 21 (second reaction gas flow path 23). Accordingly, the power generation cell C can increase the reaction rate of reaction gas in the power generation region A1.

Moreover, in the power generation cell C of the present embodiment, even if the cathode side separator 2 has deflection when the power generation cell C is stacked with a predetermined load, the cathode side separator 2 at a part corresponding to the bypass flow path is allowed to extend in the direction in which the reaction gas flow paths 21 are arranged, and accordingly, the deflection is solved. Thus, the power generation cell C can more reliably prevent generation of surface pressure variance of the cathode side separator 2.

In the anode side separator 3 of the power generation cell C of the present embodiment, as well, the top part 31al of each convex part 31a of a reaction gas flow path 31 is assumed to be positioned on the straight line L connecting the top parts 34al of two adjacent convex parts 34a of the sealing part 34 or protrude on the sealing part 24 side beyond the straight line L.

Thus, the power generation cell C can more effectively prevent leakage of reaction gas from the reaction gas flow paths 21 and 31 and the sealing parts 24 and 34 than in conventional cases.

In the power generation cell C of the present embodiment, the convex parts 21a of the reaction gas flow paths 21 and 31 face the concave parts 24b of the sealing parts 24 and 34 at upstream parts of the reaction gas flow paths 21 and 31 on the reaction gas supply ports 10a and 10e side, in other words, the reaction gas flow paths 21 and 31 closest to the sealing parts 24 and 34.

According to such a power generation cell C, the flow rate of reaction gas bypassing the power generation region A1 can be more reliably decreased. Moreover, the power generation cell C can increase the reaction rate of reaction gas in the power generation region A1.

The cathode side separator 2 of the power generation cell C of the present embodiment includes the first reaction gas flow paths 22 arranged alongside each other to supply reaction gas to the power generation region A1, and the second reaction gas flow paths 23 corresponding to the non-power generation region A2 and provided between the sealing part 24 and the first reaction gas flow paths 22. The first reaction gas flow paths 22 and the second reaction gas flow paths 23 are formed such that the phases of their wavy shapes match each other.

The anode side separator 3 includes the first reaction gas flow paths 32 arranged alongside each other to supply reaction gas to the power generation region A1, and the second reaction gas flow paths 33 corresponding to the non-power generation region A2 and provided between the sealing part 34 and the first reaction gas flow paths 32. The power generation cell C is assumed to have a configuration in which the first reaction gas flow paths 32 and the second reaction gas flow paths 33 are formed such that the phases of their wavy shapes match each other.

In such a power generation cell C, formation parts of the reaction gas flow paths 21 or 31 extend to parts corresponding to the bypass flow path 25 or 35 to cancel deflection when the power generation cell C is stacked. In this case, since the reaction gas flow paths 21 or 31 are constituted by the first reaction gas flow paths 22 or 32 arranged alongside each other and the second reaction gas flow paths 23 or 33 and the phases of their wavy shapes are matched, the formation parts of the reaction gas flow paths 21 or 31 uniformly expand in a direction along the surfaces of the cathode side separator 2 and the anode side separator 3. Thus, generation of surface pressure variance on the cathode side separator 2 and the anode side separator 3 is more reliably prevented.

In the cathode side separator 2 of the power generation cell C of the present embodiment, the second reaction gas flow paths 23 contact the gas diffusion layer of the cathode 12a extending to the non-power generation region A2.

According to such a power generation cell C, water generated at the cathode 12a in the power generation region A1 partially moves to the gas diffusion layer of the cathode 12a in the non-power generation region A2 by capillary action.

The generated water having moved to the cathode 12a in the non-power generation region A2 is discharged along with reaction gas (oxygen containing gas) flowing through the second reaction gas flow paths 23.

According to such a power generation cell C, water generated at the cathode 12a is discharged along with reaction gas through the first reaction gas flow paths 22 and the second reaction gas flow paths 23. Flooding of the cathode 12a due to water generated at power generation is more reliably prevented.

Although the embodiment of the present invention is described above, the present invention is not limited to the embodiment but may be performed in various forms.

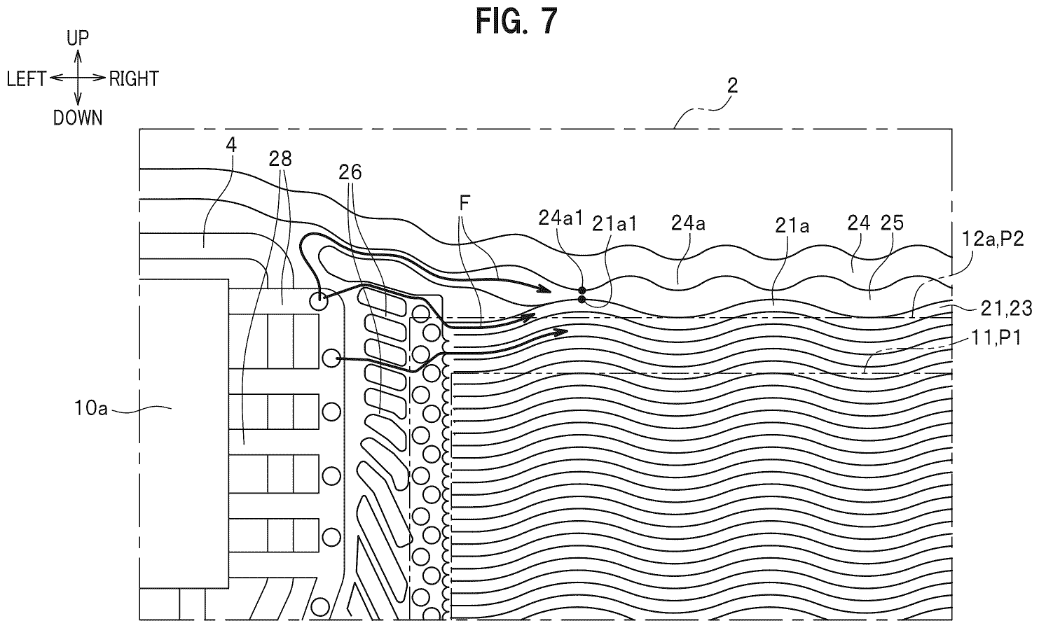

FIG. 7 corresponds to FIG. 6A in the embodiment and is a partially enlarged plan view of the cathode side separator 2 in the power generation cell C according to another embodiment. In FIG. 7, the same constituent component as in the embodiment is denoted by the same reference sign, and detailed description thereof will be omitted.

In the cathode side separator 2 of the power generation cell C shown in FIG. 7, unlike the cathode side separator 2 shown in FIG. 6A, the top part 21al of each convex part 21a of a reaction gas flow path 21 and the top part 24al of the corresponding convex part 24a of the sealing part 24 are formed at facing positions.

At the upstream part of the reaction gas flow path 21 on the reaction gas supply port 10a side, in other words, the reaction gas flow path 21 closest to the sealing part 24, as well, the top part 21al of each convex part 21a of the reaction gas flow path 21 and the top part 24al of the corresponding convex part 24a of the sealing part 24 are formed at facing positions.

In the power generation cell C, a regulation part that regulates inflow reaction gas to the bypass flow path 25 is formed by each convex part 24a of the sealing part 24 and the corresponding convex part 21a of the reaction gas flow path 21.

This configuration is not limited to the cathode side separator 2 but is also applicable to the anode side separator 3.

According to such a power generation cell C, interval setting (positioning) of each convex part 24a or 34a of the sealing part 24 or 34 and the corresponding convex part 21a or 31a of the reaction gas flow path 21 or 31 is easy and the freedom of designing a regulation part improves.

Although the wavelength of the waveform of the sealing part 24 or 34 is set to be half the wavelength of the waveform of each reaction gas flow path 21 or 31 in the embodiment, the present invention is not limited thereto but the wavelengths may be set as appropriate so that a reaction gas regulation part is provided between each convex part 24a or 34a of the sealing part 24 or 34 and the corresponding convex part 21a or 31a of the reaction gas flow path 21 or 31.

The sealing parts 24 and 34 in the embodiment are made of the beads of the cathode side separator 2 and the anode side separator 3, but wavy seals made of elastic members may be provided instead. The seals may be made of elastic members provided on the top surfaces of the beads of the cathode side separator 2 and the anode side separator 3.

What is claimed is:

1. A power generation cell comprising:
an electrolyte membrane electrode assembly provided with electrodes on respective sides of an electrolyte membrane;
a resin frame part provided at an outer peripheral part of the electrolyte membrane electrode assembly; and
a separator disposed on each side of the electrolyte membrane electrode assembly, wherein
the separator is a plate-shaped component made of metal and provided with a reaction gas flow path that has a wavy shape and through which reaction gas flows along the electrolyte membrane electrode assembly from one end of the separator toward the other end, and a sealing part contacting the resin frame part and surrounding the reaction gas flow path to prevent leakage of the reaction gas, and
the sealing part includes a plurality of top parts that are convex on the reaction gas flow path side, and a top part of the reaction gas flow path, which is convex on the sealing part side is positioned on a straight line connecting two adjacent top parts of the sealing part or protrudes on the sealing part side beyond the straight line.

2. The power generation cell according to claim 1, wherein
the separator is provided with a reaction gas supply port for supplying reaction gas to the reaction gas flow path,
a top part of the reaction gas flow path on the reaction gas supply port side, which is convex on the sealing part side is positioned between two adjacent top parts of the sealing part, and
a regulation part that regulates inflow of reaction gas between the reaction gas flow path and the sealing part is formed by a convex part forming the top part of the sealing part and a convex part forming the top part of the reaction gas flow path.

3. A power generation cell comprising:
an electrolyte membrane electrode assembly provided with electrodes on respective sides of an electrolyte membrane;
a resin frame part provided at an outer peripheral part of the electrolyte membrane electrode assembly; and
a separator disposed on each side of the electrolyte membrane electrode assembly, wherein
the separator is a plate-shaped component made of metal and provided with a reaction gas flow path that has a wavy shape and through which reaction gas flows along the electrolyte membrane electrode assembly from one end of the separator toward the other end, and a sealing part contacting the resin frame part and surrounding the reaction gas flow path to prevent leakage of the reaction gas, and
the sealing part includes a top part that is convex on the reaction gas flow path side, and a top part of the reaction gas flow path, which is convex on the sealing part side is formed at a position facing the top part of the sealing part, which is convex on the reaction gas flow path side.

4. The power generation cell according to claim 3, wherein
the separator is provided with a reaction gas supply port for supplying reaction gas to the reaction gas flow path,
a top part of the reaction gas flow path on the reaction gas supply port side, which is convex on the sealing part side is provided at a position facing the top part of the sealing part, and
a regulation part that regulates inflow of reaction gas between the reaction gas flow path and the sealing part is formed by a convex part forming the top part of the sealing part and a convex part forming the top part of the reaction gas flow path.

5. The power generation cell according to claim 1, wherein
the reaction gas flow path includes
a plurality of first reaction gas flow paths arranged alongside each other to supply reaction gas to a power generation region of the electrolyte membrane electrode assembly, and
a second reaction gas flow path corresponding to a non-power generation region of the electrolyte membrane electrode assembly and arranged alongside the first reaction gas flow paths between the sealing part and the first reaction gas flow paths, and
the plurality of first reaction gas flow paths and the second reaction gas flow path are formed such that the phases of wavy shapes of the first and second reaction gas flow paths match each other.

6. The power generation cell according to claim 3, wherein
the reaction gas flow path includes
a plurality of first reaction gas flow paths arranged alongside each other to supply reaction gas to a power generation region of the electrolyte membrane electrode assembly, and
a second reaction gas flow path corresponding to a non-power generation region of the electrolyte membrane electrode assembly and arranged alongside the first reaction gas flow paths between the sealing part and the first reaction gas flow paths, and
the plurality of first reaction gas flow paths and the second reaction gas flow path are formed such that the phases of wavy shapes of the first and second reaction gas flow paths match each other.

7. The power generation cell according to claim 5, wherein
the outer peripheral part of the electrolyte membrane electrode assembly includes a non-power generation region where the electrodes are partially placed over the resin frame part, and
the second reaction gas flow path contacts gas diffusion layers of the electrodes.

8. The power generation cell according to claim 6, wherein
the outer peripheral part of the electrolyte membrane electrode assembly includes a non-power generation region where the electrodes are partially placed over the resin frame part, and
the second reaction gas flow path contacts gas diffusion layers of the electrodes.
